(19) United States
(12) Patent Application Publication
(10) Pub. No.: US 2012/0028116 A1
(43) Pub. Date: Feb. 2, 2012

(54) COMPOSITION FOR PRODUCING POSITIVE ELECTRODE FOR ELECTRICITY STORAGE DEVICE, POSITIVE ELECTRODE FOR ELECTRICITY STORAGE DEVICE MADE WITH SAID COMPOSITION, AND ELECTRICITY STORAGE DEVICE COMPRISING SAME

(76) Inventors: Won-Gil Choi, Gyeonggi-do (KR); Kim Pyung-Kyu, Incheon (KR); Jun-Hwan Jeong, Incheon (KR); Byeong-Sun Lee, Seoul (KR); Song-Yi Choi, Incheon (KR); Jung-Ae Kim, Seoul (KR); Byung-Jun Lee, Seoul (KR)

(21) Appl. No.: 13/201,589

(22) PCT Filed: Feb. 17, 2010
(86) PCT No.: PCT/KR2010/000990

§ 371 Date: Oct. 24, 2011

(30) Foreign Application Priority Data
Feb. 17, 2009 (KR) 10-2009-0013125
Aug. 28, 2009 (KR) 10-2009-0080637

(51) Int. Cl. H01M 4/583; H01G 9/04; B29C 47/00; H01M 4/64; H01B 1/04; B82Y 30/00

(52) U.S. Cl. 429/211; 429/231.8; 252/502; 252/506; 361/516; 264/465; 977/734

(57) ABSTRACT

This invention relates to a composition for producing a cathode for an electricity storage device, including carbon nanofibers prepared by electrospinning a spinning solution including a cathode active material, a conductive material and a carbon fiber precursor; and a binder, and to a cathode for an electricity storage device made with the composition and to an electricity storage device including the cathode. The composition for producing a cathode includes carbon nanofibers instead of part or all of a conductive material, a dispersant and/or a binder, so that the cathode has remarkably increased specific surface area and electrical conductivity (decreased resistance), thus maximizing the efficiency of the cathode active material and the capacity.

### TECHNICAL FIELD

The present invention relates to a composition for producing a cathode for an electricity storage device, a cathode for an electricity storage device made with the composition, and an electricity storage device including the cathode.

### BACKGROUND ART

A device for storing electric energy (hereinafter referred to as “an electricity storage device”) is employed in systems requiring power supply, such as a variety of portable electronic instruments, electric vehicles, etc., or systems that adjust or supply an instantaneous overload. Such an electricity storage device includes for example a battery, a capacitor, etc. Lithium secondary batteries and lithium ion capacitors (LIC) are receiving great attention these days.

A lithium secondary battery is suitable for a high current load, and has a large capacity and a long lifetime without having to include memory effects such as a decrease in capacity of the battery due to charging and discharging, and also has a very low self-discharge rate even after discharging. Thus, this battery is utilized in the very wide fields of portable instruments including notebook computers, mobile phones, etc., industrial electromotive tools, portable vacuum cleaners for home use, and hybrid electric vehicles or electric vehicles.

However, lithium secondary batteries are known to typically have instability problems at high temperature, and at low temperature to have poor motive power and low charging properties. In particular, a drastic decrease in the capacity of a lithium secondary battery in a fast charge/discharge environment is regarded as being in need of an urgent solution in the field of high-output lithium secondary batteries. Meanwhile, with the aim of solving the problems of lithium secondary batteries, thorough research into optimizing an electrode material to increase the utility of an electrode active material is being carried out.

A lithium ion capacitor (LIC) may be manufactured by using for example activated carbon as a cathode active material and graphite doped with lithium ions as an anode active material. Such a hybrid type LIC has a larger capacity and its voltage is higher by about 5.6˜3.8 V, compared to supercapacitors.

However, in order to further improve the performance of the LIC, the utility of the electrode active material should be increased. For this, attempts to optimize the electrode material are underway.

Typically, the electrode of an electricity storage device such as a lithium secondary battery and a lithium ion capacitor includes an electrode active material, a conductive material and a binder, wherein the amount of the active material (e.g. LiMn₂O₄ or activated carbon) is about 80%, the amount of conductive material (e.g. Super-P) is about 10%, and the amount of binder is about 10%.

The binder functions as a cross-linker for binding the electrode active material and the conductive material which constitute an electrode, and examples thereof include carboxy methyl cellulose (CMC), polyvinylpyrrolidone (PVP), a fluorine-based material such as polytetrafluoroethylene (PTFE) or polyvinylidene fluoride (PVdF) powder or emulsion, and a rubber-based material such as styrene butadiene rubber (SBR). These binders are polymeric and most of them have no conductivity. Thus, the binder has high self-resistance (e.g. conductivity of PTFE=10⁻¹⁸ S/cm) undesirably causing resistance of the electrode to increase, and may react with a material present in the electrode to thus increase resistance or generate a gas (HF). Hence, the minimal amount of such a binder should be used.

However, a decrease in the amount of the binder in the electrode of the electricity storage device may cause the bond between the electrode active material and a collector to weaken, undesirably breaking the active material layer of an electrode, which may drastically reduce the capacity of the battery. Therefore, the development of a binder that has solved these problems or the development of an alternative material that may be used instead of part or all of the amount of the binder is considered very important in terms of increasing the utility of the electrode active material, and is particularly essential for high-output electricity storage devices.

### DISCLOSURE

### Technical Problem

Accordingly, the present invention has been made keeping in mind the above problems occurring in the related art, and an object of the present invention is to provide a composition for producing a cathode for an electricity storage device, in which carbon nanofibers are used instead of part or all of a conductive material, a dispersant and/or a binder which are conventionally utilized, so that a cathode may have greatly increased specific surface area and electrical conductivity (decreased resistance), thus maximizing the efficiency of a cathode active material and its capacity, and in particular, upon fast charging/discharging, minimizing the decrease in the capacity of the cathode active material, thus improving C-rate properties.

Another object of the present invention is to provide a composition for producing a cathode for an electricity storage device, in which a cathode active material and a conductive material are efficiently dispersed and thus uniformly distributed in a cathode even without the use of an additional dispersant and are strongly bound to each other, thus enabling the production of a cathode having high durability.

A further object of the present invention is to provide a cathode for an electricity storage device, which is formed using the composition for producing a cathode, so that the efficiency of a cathode active material is good, the capacity thereof is large, fast charging/discharging is possible thanks to superior C-rate properties, and pathways between active material particles are maintained due to a large specific surface area during charge/discharge cycles, thus increasing the lifetime, and also to provide an electricity storage device including such a cathode.

### Technical Solution

An aspect of the present invention provides a composition for producing a cathode for an electricity storage device, comprising a cathode active material; a conductive material; carbon nanofibers prepared by electrospinning a spinning solution comprising a carbon fiber precursor; and a binder.

Another aspect of the present invention provides a cathode for an electricity storage device, comprising a collector; and a cathode active material layer applied on the collector, wherein the cathode active material layer is formed of the above composition for producing a cathode.

A further aspect of the present invention provides an electricity storage device, comprising a cathode, an anode, and an electrolyte, wherein the cathode is the cathode according to the present invention.

Still a further aspect of the present invention provides a method of preparing a composition for producing a cathode for an electricity storage device, comprising (a) electrospinning a spinning solution including a carbon fiber precursor, thus preparing a nanofiber web; (b) subjecting the nanofiber web prepared in (a) to oxidative stabilization in air; (c) subjecting the oxidative stabilized nanofiber web prepared in (b) to carbonization in an inert gas atmosphere or in a vacuum; (d) grinding carbon nanofibers obtained in (c); and (e) mixing the carbon nanofibers ground in (d) with a cathode active material, a conductive material and a binder, thus preparing a slurry.

### Advantageous Effects

According to the present invention, a composition for producing a cathode for an electricity storage device includes carbon nanofibers instead of part or all of a conductive material, a dispersant and/or a binder which are conventionally used, so that the specific surface area of the cathode can be drastically increased and its electrical conductivity also increased (decreased resistance), thus maximizing the efficiency of a cathode active material. Particularly upon fast charging/discharging, a decrease in the capacity of the cathode active material is minimized, thus greatly improving C-rate properties.

Also according to the present invention, the composition for producing a cathode enables a cathode active material and a conductive material to be efficiently dispersed and thus uniformly distributed in a cathode even without the use of an additional dispersant, so that a large-sized electrode can be manufactured to be very uniform. Even when pressure is not applied using a roller, the components can be five-dimensionally strongly bound to each other, thereby enabling the formation of a cathode having high durability for use in an electricity storage device.

Also according to the present invention, an electricity storage device including the cathode formed using the composition for producing a cathode has superior efficiency of a cathode active material and its large capacity, and enables fast charging/discharging thanks to superior C-rate properties, and has a long lifetime because pathways between active material particles are maintained due to a large specific surface area during charge/discharge cycles.

### DESCRIPTION OF DRAWINGS

FIG. 1 is a schematic view showing an electrospinning process according to the present invention and a typical vapor growth process, in order to manufacture carbon nanofibers;

FIG. 2 is a scanning electron microscope (SEM) image showing a polyacrylonitrile nanofiber web prepared using electrospinning in Preparative Example 1;

FIG. 3 is an SEM image showing a pitch nanofiber web prepared using electrospinning in Preparative Example 1;

FIG. 4 is an SEM image showing the cross-section of the polyacrylonitrile nanofiber web prepared using electrospinning in Preparative Example 1;

FIG. 5 is of an SEM image and graphs showing the average diameter of carbon nanofibers of Preparative Example 2 [(a) carbonization temperature of 1000° C. (average diameter: 320 nm), (b) carbonization temperature of 1100° C. (average diameter: 270 nm), and (c) carbonization temperature of 900° C. (average diameter: 220 nm)];

FIG. 6 is an SEM image showing carbon nanofibers of Preparative Example 4 cut using a chopper;

FIG. 7 is an SEM image showing the surface of a cathode for a lithium secondary battery, manufactured in Example 1;

FIG. 8 is an SEM image showing the surface of a cathode for a lithium secondary battery, manufactured in Comparative Example 1;

FIG. 9 is a graph showing C-rate properties of the cathode for a lithium secondary battery of Example 1 and the cathode for a lithium secondary battery of Comparative Example 1;

FIG. 10 is of graphs showing the voltage of a lithium ion capacitor including the cathode of Example 2 and a lithium ion capacitor including the cathode of Comparative Example 2 ((a): Example 2, (b): Comparative Example 2); and

FIG. 11 is of graphs showing the capacity of a lithium ion capacitor including the cathode of Example 2 and a lithium ion capacitor including the cathode of Comparative Example 2 ((a): Example 2, (b): Comparative Example 2).

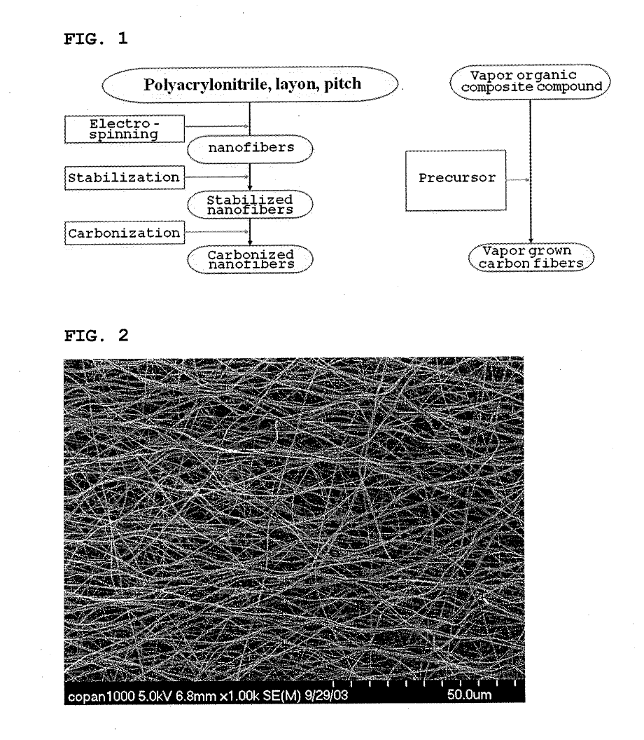

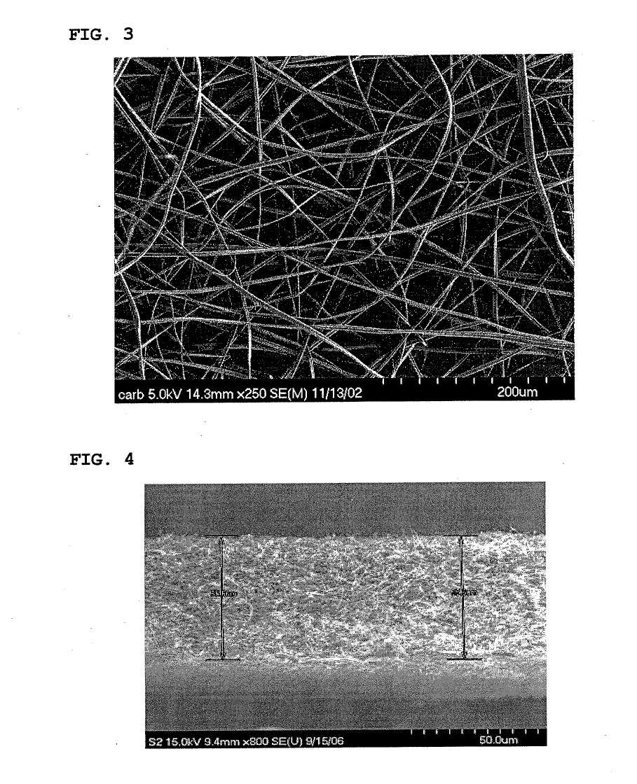

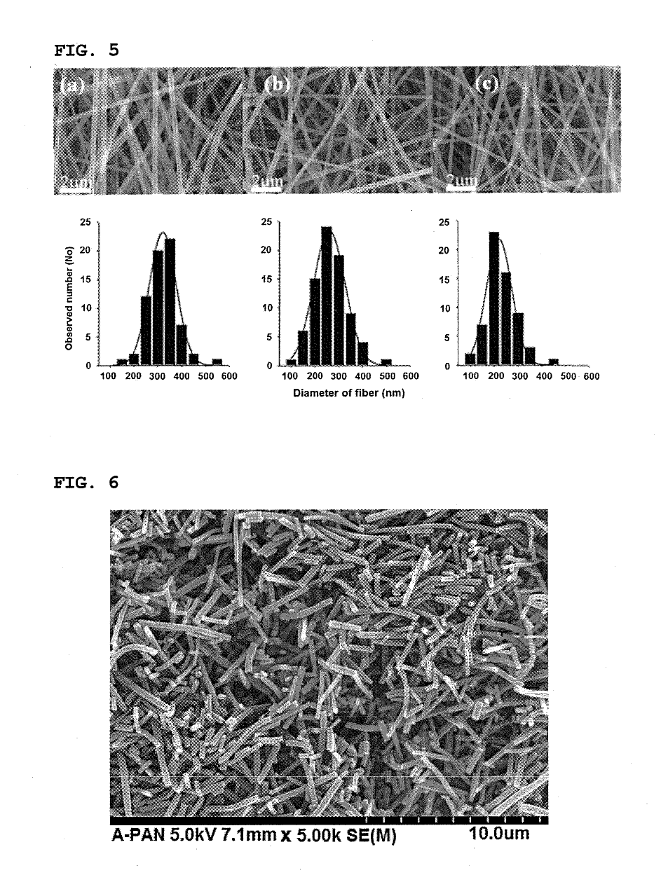

### BEST MODE

The present invention pertains to a composition for producing a cathode for an electricity storage device, comprising a cathode active material; a conductive material; carbon nanofibers prepared by electrospinning a spinning solution comprising a carbon fiber precursor; and a binder.

In the present invention, the electricity storage device includes a battery and a capacitor, in particular, a lithium secondary battery, a lithium ion capacitor (LIC), etc.

The composition for producing a cathode comprises, based on the total weight of the composition, 60˜95 wt % of the cathode active material, 3˜20 wt % of the conductive material, 1˜30 wt % of the carbon nanofibers, and 1˜20 wt % of the binder.

In the composition for producing a cathode for an electricity storage device according to the present invention, the cathode active material may be used without limitation so long as it is known in the art.

For example, in the case where the electricity storage device is a lithium secondary battery, a cathode active material such as LiMn₂O₄, LiNi₂O₄, LiCoO₂, LiNiO₂, Li₂MnO₃, LiFePO₄, LiNiₓCo_{y}O₂ (0<x<=0.15, 0<y<=0.85), V₂O₅, CuV₂O₆, NaMnO₂, NaFeO₂, etc., may be used, and a combination of two or more thereof, namely, Li₂MnO₃/LiMnO₂ or Li₂MnO₃/LiNiO₂ may also be used. Among them, however, LiMn₂O₄ is favorable in the present invention because Mn reserves are abundant, no environmental problems are caused, and fast discharging is possible.

In the present invention, commercially available LiMn₂O₄ may be used, but nano-sized LiMn₂O₄ electrospun from a precursor of LiMn₂O₄ may also be used. Specifically, 17 wt % of an acetate salt of lithium, namely, Li(CH₃COO).H₂O, and 83 wt % of an acetate salt of manganese, namely, Mn(CH₃COO)₂.4H₂O are dissolved in distilled water, after which the resultant solution is mixed with a polymer solution thus preparing an electrospinning solution, which is then electrospun thereby manufacturing nano-sized LiMn₂O₄. Alternatively, LiNO₃ and Mn(NO₃)₂.4H₂O may be mixed at a weight ratio of 1:1 or 1:2 thus preparing a 1 mol aqueous solution which may then be mixed with a polymer solution, so that the resultant mixture may be used as a precursor for electrospinning or electrospraying.

Also, in the case where the electricity storage device is a lithium ion capacitor, a cathode active material such as activated carbon may be used.

If the amount of the cathode active material in the composition for producing a cathode for an electricity storage device is too small, the capacity of an electrode is decreased. On the other hand, if the amount thereof is too large, bindability or conductivity of a cathode active material may be deteriorated. Thus, the cathode active material is preferably used in an amount of 60˜95 wt % based on the total weight of the composition according to the present invention.

In the composition according to the present invention, the conductive material may be used without limitation so long as it is known in the art. Examples of the conductive material include graphite such as natural graphite or artificial graphite; and carbon black such as acetylene black, ketjen black, channel black, furnace black, lamp black, summer black, Super-p, toka black, denka black. The type of conductive material may be appropriately selected taking into consideration the properties of the composition for producing a cathode. In the composition for producing a cathode, the amount of the conductive material may be adjusted in consideration of the conductivity of an electrode and the amounts of other components, and is preferably set to 3˜20 wt % based on the total weight of the composition.

In the composition according to the present invention, the binder functions to bind the cathode active material and the conductive material to each other and also to bind the above materials to a collector, and may be used without limitation so long as it is known in the art. Examples of the binder include carboxy methyl cellulose (CMC); polyvinylpyrrolidone (PVP); a fluorine-based material such as polytetrafluoroethylene (PTFE), polyvinylidene fluoride (PVdF) powder or emulsion; a rubber-based material such as styrene butadiene rubber (SBR), etc. Such binders are polymeric and most of them have no conductivity.

In the composition for producing a cathode according to the present invention, the amount of the binder may be set in consideration of the bindability between components for forming an electrode and between such components and a collector. The binder may be used in an amount of 1˜20 wt % based on the total weight of the composition taking into consideration the magnitude of resistance of the electrode and the bindability. In particular, because the composition for producing a cathode according to the present invention includes carbon nanofibers, the binder is preferably contained in an amount of 1˜8 wt %, and more preferably 3˜7 wt %.

In the composition according to the present invention, the carbon nanofibers are very important because they may be used instead of part or all of the conductive material, the dispersant, and/or the binder. The carbon nanofibers play a role in allowing a cathode to have a large specific surface area, and may greatly reduce the electrode resistance thanks to very high electrical conductivity, thereby increasing the capacity and efficiency of the cathode active material. Furthermore, a decrease in capacity of the cathode active material is minimized upon fast charging/discharging, thus maximizing C-rate properties. Hence, when the composition for producing a cathode, including such carbon nanofibers, is used, it is possible to manufacture a lithium secondary battery enabling fast charging/discharging, and also a lithium ion capacitor having large capacity and high voltage.

Also, the carbon nanofibers cause the cathode active material and the conductive material to be well dispersed and uniformly distributed in the cathode even without the use of a dispersant, thus enabling a large-sized electrode to be very uniformly manufactured. In the case where a sheet is manufactured from a conventional composition for producing a cathode, the degree of dispersion of a slurry is decreased in the course of manufacturing the sheet, so that the start portion of the sheet and the end portion thereof are not uniform, and thus the size of the manufactured sheet cannot but be limited.

Also, the carbon nanofibers may increase the bindability of the cathode active material and the conductive material. Even when pressure is not applied using a roller, five-dimensional strong bonding may be formed thus enabling the production of a cathode having high durability.

The carbon nanofibers may be used in an amount of 1˜30 wt %, preferably 3˜15 wt %, and more preferably 3˜7 wt %, based on the total weight of the composition. If the amount of the carbon nanofibers is less than 1 wt %, a comparatively large amount of the conventional polymer binder should be added, and improvements in bindability and electrical conductivity become insignificant, and it is difficult to exhibit a function that disperses the other components. On the other hand, if the amount thereof exceeds 30 wt %, the amount of the cathode active material is correspondingly decreased, undesirably reducing the capacity of the electrode.

The carbon nanofibers are manufactured via electrospinning using a spinning solution including a carbon fiber precursor, and may have an average diameter of 1 μm or less, and preferably 800 μm or less, in order to ensure the specific surface area necessary for performing the function of a binder. Also, the carbon nanofibers have an average length of 0.5˜30 μm, and preferably 1˜15 μm. If the average length of the carbon nanofibers is less than 0.5 μm, these carbon nanofibers cannot function as a cross-linker of electrode materials. In contrast, if the average length thereof exceeds 30 μm, it is difficult to prepare a slurry, and when an electrode is manufactured via casting using the slurry, the thickness of the electrode cannot be undesirably controlled. The carbon nanofibers preferably have an aspect ratio of 0.5˜30.

The carbon nanofibers used for the composition for producing a cathode according to the present invention are manufactured using an electrospinning process, and have a fiber surface state and density different from those of fibers resulting from a vapor growth process, and is advantageous in terms of including pores controlled via heat treatment.

In the case of carbon nanofibers manufactured using a vapor growth process, the use of methane is essential, and the temperature of an inlet through which materials are fed is 700° C. or less, but heat treatment should be conducted at a very high temperature of 1100˜1500° C. However, the carbon nanofibers used in the present invention are manufactured via electrospinning, stabilization and carbonization, and the maximum temperature upon carbonization does not exceed 1100° C., thus facilitating the preparation of carbon nanofibers.

Infra is a description of a method of manufacturing the carbon nanofibers.

In the present invention, the carbon nanofibers are manufactured by (a) electrospinning a spinning solution including a carbon fiber precursor thus preparing a nanofiber web; (b) subjecting the nanofiber web prepared in (a) to oxidative stabilization in air; (c) subjecting the oxidative stabilized nanofiber web obtained in (b) to carbonization in an inert gas atmosphere or in a vacuum; and (d) grinding carbon nanofibers obtained in (c).

In (a), the spinning solution may further include a thermally labile polymer in addition to the carbon fiber precursor. In this case, the thermally labile polymer is decomposed upon carbonization at high temperature, so that pores are formed in the carbon nanofibers. Such pores may be controlled by the amount of the thermally labile polymer upon preparation of the spinning solution.

In the present invention, the carbon fiber precursor may be used without limitation so long as it may be subjected to electrospinning as a material known in the art. Examples thereof include polyacrylonitrile (PAN), phenol-resin, polybenzylimidazole (PBI), cellulose, phenol, pitch, polyimide (PI), etc., which may be used alone or in combinations of two or more.

In the present invention, the thermally labile polymer may be used without limitation so long as it is known in the art. Examples thereof include polyurethane, polyetherurethane, polyurethane copolymer, cellulose acetate, cellulose acetate butyrate, cellulose acetate propionate, polymethylmethacrylate (PMMA), polymethylacrylate (PMA), polyacryl copolymer, polyvinyl acetate (PVAc), polyvinyl acetate copolymer, polyvinylalcohol (PVA), polyfurfuryl alcohol (PPFA), polystyrene, polystyrene copolymer, polyethylene oxide (PEO), polypropylene oxide (PPO), polyethylene oxide copolymer, polypropylene oxide copolymer, polycarbonate (PC), polyvinyl chloride (PVC), polycaprolactone, polyvinylpyrrolidone (PVP), polyvinyl fluoride, polyvinylidene fluoride copolymer, polyamide, etc., which may be used alone or in combinations of two or more.

In the present invention, electrospinning is performed by supplying the spinning solution to an electrospinning nozzle using a feeder, and forming a high electric field (10˜100 kV) using a high voltage generator between the nozzle and the collector. The magnitude of the electric field is affected by the distance between the nozzle and the collector, and the relationship therebetween is utilized to facilitate electrospinning. As such, a typical electrospinning device may be used, and an electro-brown method or a centrifugal electrospinning method may be adopted. The nanofibers thus manufactured are provided in the form of nonwoven fabric having an average diameter of less than 1 μm.

The thickness of the nanofiber web electrospun upon electrospinning should be uniform. In the case where the thickness is non-uniform or is partially too thick, an exothermic reaction may occur on the portion where the thickness is comparatively large upon stabilization, thus increasing the enthalpy, so that the nanofiber web may be burned.

In (b), oxidative stabilization may be performed by using any method known in the art without limitation. For example, the manufactured nanofiber web is placed in an electric furnace the temperature and the air flow rate of which may be controlled, heated from room temperature to a temperature not higher than a glass transition temperature at a rate of 0.5˜5° C./min, thus obtaining infusible fibers. As such, if there is too much hydrogen or to little oxygen, the weight may increase, which may cause an exothermic reaction.

In (c), carbonization may be performed by using any method known in the art without limitation. The oxidative stabilized fibers are treated in the temperature range of 500˜1500° C. in an inert atmosphere or in a vacuum, thus obtaining carbonized nanofiber web. The diameter of the nanofibers of the nanofiber web thus carbonized is about 100˜1000 nm.

Also, the carbonized nanofibers may be further subjected to activation and/or graphitization. The graphitization is performed by treating the carbonized nanofiber web using a graphitization furnace at a temperature not higher than 3000° C., thus obtaining a graphitized nanofiber web.

In (d), the carbon nanofiber web may be ground using a ball mill or a chopper, so that it is cut to an average length of 0.5˜30 μm. In the case where a ball mill is used, dry and/or wet grinding may be used, and the resultant carbon nanofibers have a length that decreases in proportion to an increase in ball milling time. In the case where the energy is totally high upon ball milling, a large amount of fine powder may be generated. Also, in the case where a chopper is used, a large amount of fine powder is not generated, and the length of the carbon nanofibers is initially about 30˜100 μm, and becomes 10˜50 μm and then 1˜8 μm over time.

In addition, the present invention provides a cathode for an electricity storage device, comprising a collector; and a cathode active material layer applied on the collector, wherein the cathode active material layer is formed of the composition for producing a cathode for an electricity storage device according to, the present invention.

The cathode for an electricity storage device according to the present invention has very high efficiency of the cathode active material and may be very usefully applied to a high-output lithium secondary battery or the like because a decrease in capacity of the cathode active material is not large upon fast charging/discharging. Furthermore, this cathode has a large capacity and a high voltage and may thus be applied to a lithium ion capacitor.

In addition, the present invention provides an electricity storage device comprising a cathode, an anode, and an electrolyte, wherein the cathode is the cathode for an electricity storage device according to the present invention.

The electricity storage device may include a lithium secondary battery, a lithium ion capacitor, etc.

In addition, the present invention provides a method of preparing the composition for producing a cathode for an electricity storage device, comprising (a) electrospinning a spinning solution including a carbon fiber precursor thus preparing a nanofiber web; (b) subjecting the nanofiber web prepared in (a) to oxidative stabilization in air; (c) subjecting the oxidative stabilized nanofiber web obtained in (b) to carbonization in an inert gas atmosphere or in a vacuum; (d) grinding carbon nanofibers obtained in (c); and (e) mixing the carbon nanofibers ground in (d) with a cathode active material, a conductive material, and a binder, thus preparing a slurry.

In (e), a solvent may be further added to obtain the slurry.

In (a), the spinning solution may further include a thermally labile polymer in addition to the carbon fiber precursor.

The cathode for an electricity storage device according to the present invention may be formed by coating the collector with the composition in slurry form for producing a cathode according to the present invention, thus forming the cathode active material layer on the collector. In the method of manufacturing the cathode for an electricity storage device, the cathode active material layer may be applied to a thickness of about 10˜100 μm, dried at a high temperature of about 100˜150° C., and then cut to a predetermined length, depending on the end use. The coating of the collector with the composition for producing a cathode may be performed on one surface, both surfaces, or the entire surface thereof.

### MODE FOR INVENTION

A better understanding of the present invention may be obtained through the following preparative examples and examples which are set forth to illustrate, but are not to be construed as limiting the present invention.

### Preparative Example 1

### Preparation of Nanofiber Web

30 wt % (based on solid content) of a carbon fiber precursor, namely, polyacrylonitrile (PAN, Mw=180,000), based on the total weight of a spinning solution, was dissolved in a DMF solvent, thus preparing a spinning solution. This spinning solution was electrospun while being extruded via a spinneret under conditions of a voltage of 50 kV, a distance between the spinneret and the collector of 25 cm, and a rate of 0.1˜1 cc/g per hole.

By the above electrospinning process, a PAN nanofiber web of uniform thickness (thickness: 55.6 μm) comprising nanofibers having an average diameter of 800 nm and 500 nm was obtained.

Also, a pitch nanofiber web having uniform thickness was prepared in the same manner as above, with the exception that pitch was used instead of the PAN.

### Preparative Example 2

### Preparation of Carbon Nanofiber Web

The PAN nanofiber web of Preparative Example 1 was gradually heated from room temperature to 300° C. at a rate of 5° C./min using a hot air circulation furnace, and isothermally treated at 300° C. for 1 hour and thus stabilized. The stabilized nanofiber web was heated from room temperature to a temperature enabling carbonization, namely, 700˜900° C., at a rate of 5° C./min, after which the web was isothermally treated at a final temperature (700° C., 800° C. or 900° C.) for 2 hours in a nitrogen gas atmosphere and thus carbonized.

The average diameter of the nanofibers of the carbonized nanofiber web was decreased to about 400˜500 nm after carbonization at 700° C. of the nanofibers having an average diameter of 800 nm before stabilization, and was decreased to 320 nm, 270 nm and 220 nm after carbonization at 700° C., 800° C. and 900° C. respectively of the nanofibers having an average diameter of 500 nm before carbonization.

### Preparative Example 3

### Preparation of Carbon Nanofiber Web

20 wt % (based on solid content) of PAN (Mw=180,000) and 10 wt % (based on solid content) of PMMA based on the total weight of a spinning solution were dissolved in a DMF solvent, thus preparing a spinning solution. The spinning solution thus prepared was electrospun while being extruded via a spinneret under conditions of a voltage of 50 kV, a distance between the spinneret and the collector of 25 cm, and a rate of 0.1˜1 cc/g per hole. The PAN/PMMA mixed nanofiber web thus electrospun was stabilized and carbonized in the same manner as in Preparative Example 2 thus preparing a carbon nanofiber web.

The carbon nanofiber web had numerous pores formed by complete decomposition of the thermally labile polymer (PMMA) during carbonization.

### Preparative Example 4

### Grinding or Cutting of Carbon Nanofiber Web

The carbon nanofiber web of Preparative Example 2 was cut to 1˜15 μm using a ball mill or chopper, thus preparing carbon nanofibers (FIG. 6). Also, in the case where a ball mill was used, dry grinding and wet grinding were alternately carried out.

### Examples 1˜2 and Comparative Examples 1˜2

(1) Preparation of Composition for Producing Cathode for Lithium Secondary Battery and Production of Cathode

The components shown in Table 1 below were mixed in a corresponding ratio, so that a composition for producing a cathode for a lithium secondary battery was prepared in the form of a slurry.

The composition in slurry form was cast on one surface of a cathode collector, and dried, thus manufacturing a cathode for a lithium secondary battery.

TABLE 1

| | Composition | Rubbing | Scratching |
|---|---|---|---|
| Ex. 1 | LiMn₂O₄:Super-P:PVdF:CNF = | not stained with | not |
| | 80:10:5:5 | active material | scratched |
| C. | LiMn₂O₄:Super-P:PVdF = | stained with active | scratched |
| Ex. 1 | 80:10:10 | material | |

Note)
CNF: carbon nanofibers

(2) Preparation of Composition for Producing Cathode for Lithium Ion Capacitor and Production of Cathode

The components shown in Table 2 below were mixed in a corresponding ratio, so that a composition for producing a cathode for a lithium ion capacitor was prepared in the form of a slurry.

The composition in slurry form was cast on one surface of a cathode collector, and dried, thus manufacturing a cathode for a lithium ion capacitor.

TABLE 2

| | Composition (wt %) | Rubbing | Scratching |
|---|---|---|---|
| Ex. 2 | activated carbon:carbon | not stained with | not |
| | black:PTFE:CNF = 80:10:5:5 | active material | scratched |
| C. Ex. 2 | activated carbon:carbon | stained with active | scratched |
| | black:PTFE = 80:10:10 | material | |

Note)
CNF: carbon nanofibers,
PTFE: polytetrafluoroethylene

(2) Observation of Surface State of Cathode

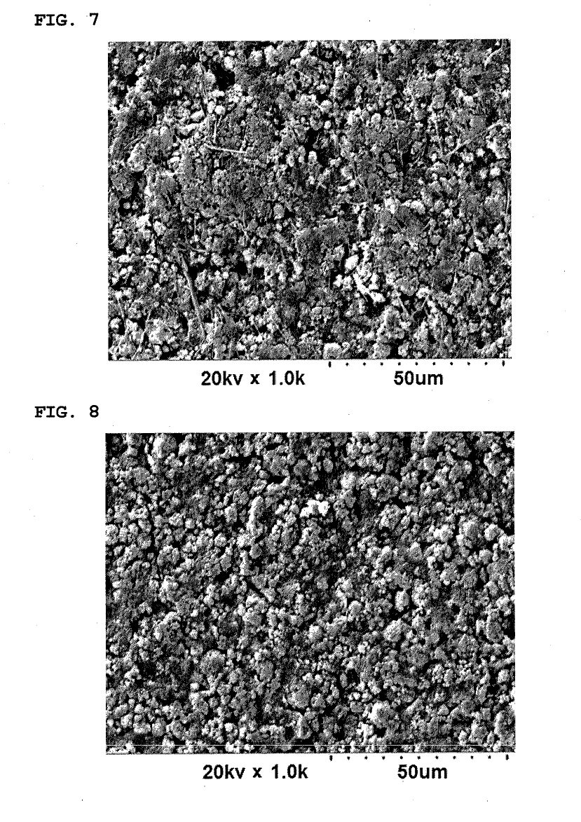

The surface of the cathode for a lithium secondary battery formed using the composition of Example 1 and the surface of the cathode for a lithium secondary battery formed using the composition of Comparative Example 1 were observed using a scanning electron microscope (SEM). As shown in FIGS. 7 and 8, the surface of the cathode formed using the composition of Example 1 according to the present invention was much more uniform because the cathode active material and the conductive material were very efficiently dispersed, compared to the cathode formed using the composition of Comparative Example 1.

(3) Test for Surface Properties of Cathode

The surface of the cathode was rubbed with the fingers and was also scratched with the fingernails to check whether the fingers were stained with the cathode active material and also whether the surface was scratched.

As is apparent from the results of Tables 1 and 2, the cathodes manufactured using the compositions of Examples 1 and 2 did not cause the hands to be stained therewith despite not using a roller, and were not scratched by fingernails. The use of the carbon nanofibers having an average diameter of 500 nm resulted in much greater bindability, compared to when using the carbon nanofibers having an average diameter of 800 nm.

However, when the cathodes of Comparative Examples 1 and 2 resulting from the composition typically used in the art was rubbed with the fingers, the fingers were stained with the cathode active material on the surface of the electrode, and when they were scratched with fingernails, the surface became scratched.

The above test results of the cathodes of Examples 1 and 2 proved that the carbon nanofibers prepared via electrospinning were very effective in binding the cathode active material and the conductive material to each other. However, the above results of the cathodes of Comparative Examples 1 and 2 showed that when only polyvinylidene fluoride was used as a binder, the bindability of the cathode active material was poor. Only when a predetermined level or more of pressure was applied using a roller at high temperature according to a conventional method of manufacturing a cathode for an electricity storage device, could sufficient bindability be obtained.

### Test Example 1

### Capacity of Cathode Active Material of Comparative Example 1

In order to evaluate whether the capacity of the cathode for a lithium secondary battery of Comparative Example 1 matches the capacity of a conventional cathode, a conventional anode using graphite as an anode active material was used, and the cathode of Comparative Example 1 was used, thus forming a pouch type full-cell battery. A separator was a product of Cell Guard 20 μm thick, and an electrolyte was composed of EC:DEC at a ratio of 1:2, and as a lithium salt LiPF₆ was used along with starlyte.

Using the battery thus manufactured, the capacities of the cathode of Comparative Example 1 and the conventionally known LiMn₂O₄ active material were compared. As shown in Table 3 below, these results were approximately matched to each other. Thus, the LiMn₂O₄ cathode of Comparative Example 1 was suitable for use as a reference.

Also as shown in Table 3 below, the electrode including the carbon nanofibers according to the present invention exhibited very superior capacity compared to the cathode of Comparative Example 3 resulting from using conventional vapor grown carbon fibers (VGCF).

TABLE 3

| | Cathode | | |
|---|---|---|---|
| | Active | | |
| | Material | Capacity | Electrolyte |
| C. Ex. 1 | LiMn₂O₄ | 127.9 mAh/g | 1M LiPF₆ EC/DEC |
| | | | (1:2); Starlyte |
| C. Ex. 3 | LiMn₂O₄ | 110.0 mAh/g | 1M LiPF₆ EC/DEC 1:1 |
| (using | | | |
| VGCF) | | | |

### Test Example 2

### Comparison of Performance of Cathode for Lithium Secondary Battery Depending on C-Rate

The ability to exhibit capacity of the cathode for a lithium secondary battery of Example 1 and that of the cathode for a lithium secondary battery of Comparative Example 1 were measured in terms of the C-rate. The results are shown in Table 4 below.

TABLE 4

| | Cathode Active | C-Rate Capacity (mAh/g) | | | |
|---|---|---|---|---|---|
| | Material | 0.5 C | 1 C | 4 | 3 C |
| Ex. 1 | LiMn₂O₄ | 124.20 | 123.77 | 121.90 | 119.20 |
| | Decrement (%) | — | 99.7 | 98.5 | 96.0 |
| C. Ex. 1 | LiMn₂O₄ | 127.90 | 122.4 | 117.58 | 113.96 |
| | Decrement (%) | — | 95.7 | 91.9 | 89.1 |

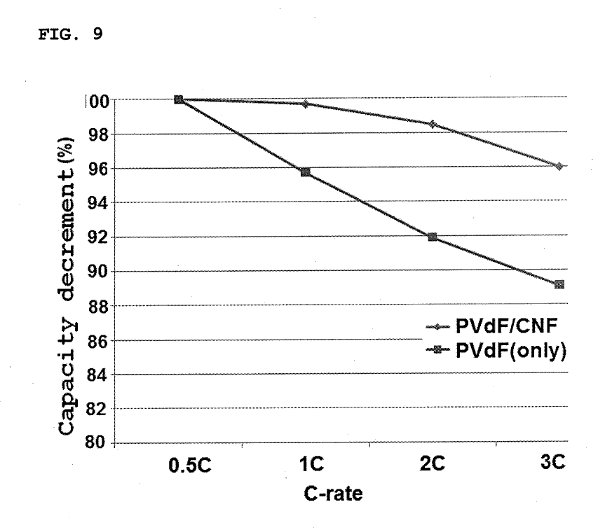

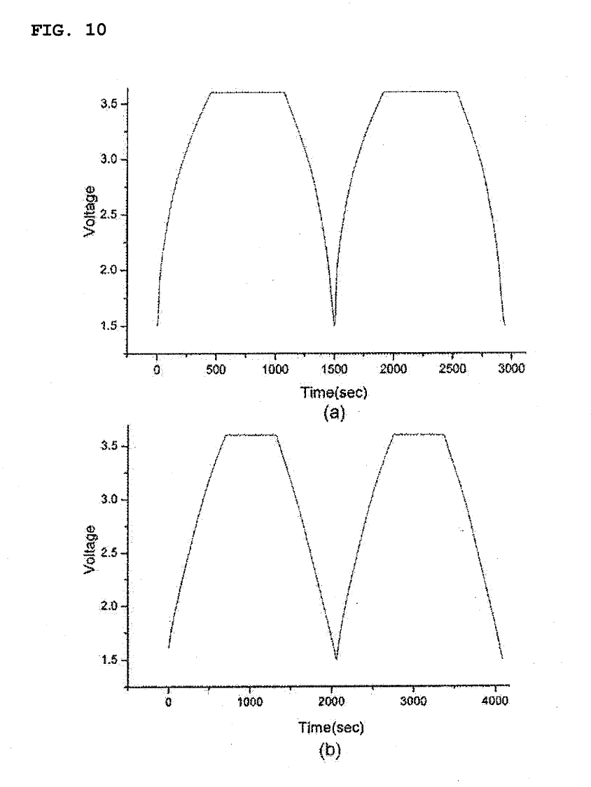

As is apparent from Table 4, the cathode of Example 1 and the cathode of Comparative Example 1 respectively exhibited 124.2 mAh/g and 127.9 mAh/g at 0.5 C, and thus had almost the same C-rate capacity. However, the cathode of Example 1 manifested 119.2 mAh/g at 3 C and the C-rate capacity was decreased by 4%, whereas the cathode of Comparative Example 1 exhibited 114.0 mAh/g at 3 C and the C-rate capacity was decreased by 10.9% (FIG. 9).

Accordingly, the cathode for a lithium secondary battery, formed using the composition for producing a cathode according to the present invention, can manifest excellent C-rate properties. Thus, the cathode for a lithium secondary battery according to the present invention has low capacity decrement upon fast charging/discharging and thus can be very usefully utilized to manufacture a high-output lithium secondary battery.

The above C-rate properties can depend on the remarkably increased specific surface area of the cathode and the drastically decreased resistance thanks to using the carbon nanofibers in the composition for producing a cathode according to the present invention.

### Test Example 3

### Comparison of Electrical Conductivity of Cathode for Lithium Secondary Battery

The electricity conductivity of the cathode for a lithium secondary battery of Example 1 and that of the cathode for a lithium secondary battery of Comparative Example 1 were measured. The results are shown in Table 5 below.

TABLE 5

| | Composition | Resistance |
|---|---|---|
| Ex. 1 | LiMn₂O₄:Super-P:PVdF:CNF = | 0.9 Ω |
| | 80:10:5:5 | |
| C. Ex. 1 | LiMn₂O₄:Super-P:PVdF = | 2.0 Ω |
| | 80:10:10 | |

As is apparent from Table 5, the cathode for a lithium secondary battery formed using the composition for producing a cathode according to the present invention exhibited resistance not more than half the resistance of the conventional electrode (Comparative Example 1), which shows that low resistance could be obtained by the carbon nanofibers contained in the cathode. As briefly mentioned in Test Example 2, such a low resistance may reduce energy loss at the cathode upon fast discharging and thus contributes to remarkably increasing the C-rate properties of the cathode. In order to evaluate the degree of contribution of the carbon nanofibers used in the present invention to an increase in electrical conductivity of the cathode for a lithium secondary battery, electrodes were manufactured using the compositions shown in Table 6 below, and the electrical conductivity thereof was measured.

TABLE 6

| | | Electrical | |
|---|---|---|---|
| | Composition | Conductivity | Resistance |
| Sample-1 | Super-P:CMC = 80:20 | 8.0 × 10⁻³ S/cm | — |
| Sample-2 | CNF:CMC = 80:20 | 2.8 × 10⁻³ S/cm | — |

Note)
CMC: carboxy methyl cellulose

As is apparent from Table 6, the electrode for a lithium secondary battery including the carbon nanofibers used in the present invention exhibited electrical conductivity about three times higher than that of the electrode for a lithium secondary battery including the same amount of Super-P used as a typical conductive material. Thereby, the carbon nanofibers can greatly contribute to increasing the electricity conductivity (decreasing the resistance) of the cathode according to the present invention.

### Test Example 4

### Comparison Resistance and Electrical Conductivity of Electrode for Lithium Ion Capacitor

The electrical conductivity of the cathode for a lithium ion capacitor of Example 2 and that of the cathode for a lithium ion capacitor of Comparative Example 2 were measured. The results are shown in Table 7 below.

TABLE 7

| | Composition (wt %) | Resistance |
|---|---|---|
| Ex. 2 | Activated Carbon:Carbon | 6 Ω |
| | Black:PTFE:CNF = 80:10:5:5 | |
| C. Ex. 2 | Activated Carbon:Carbon | 8 Ω |
| | Black:PTFE = 80:10:10 | |

Note)
CNF: carbon nanofibers,
PTFE: polytetrafluoroethylene

As is apparent from Table 7, the cathode for a lithium ion capacitor of Example 2 formed using the composition for producing a cathode according to the present invention exhibited lower resistance compared to the conventional electrode for a lithium ion capacitor (Comparative Example 2). Thus, such a low resistance can be obtained by the carbon nanofibers contained in the cathode.

### Test Example 5

### Voltage and Capacity of Lithium Ion Capacitor

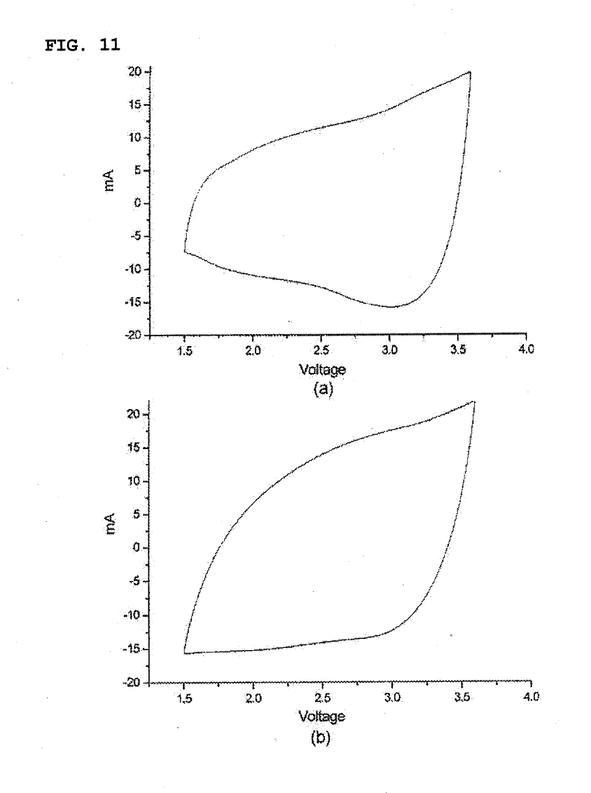

In order to measure the voltage and capacity of lithium ion capacitors including the cathodes of Example 2 and Comparative Example 2, each of the cathodes of Example 2 and Comparative Example 2, an anode formed by mixing graphite, carbon black and PVdF at a ratio of 90 wt %:5 wt %:5 wt %, and an electrolyte comprising 1M LiPF₆ EC/DEC (1:2) (Starlyte, available from Cheil Industries) were used to manufacture a lithium ion capacitor. The voltage and the capacity were measured using Maccor as a charge/discharge system via a constant current method. The measurement results are graphed in FIGS. 10 and 11. As shown in FIGS. 10 and 11, the lithium ion capacitor including the cathode of Example 2 having the carbon nanofibers exhibited higher voltage, caused no problems due to resistance and had increased capacity, compared to the lithium ion capacitor manufactured using a conventional method.

1. A composition for producing a cathode for an electricity storage device, comprising a cathode active material; a conductive material; carbon nanofibers prepared by electrospinning a spinning solution comprising a carbon fiber precursor; and a binder.

2. The composition of claim 1, comprising, based on total weight of the composition, 60˜95 wt % of the cathode active material, 3˜20 wt % of the conductive material, 1˜30 wt % of the carbon nanofibers, and 1˜20 wt % of the binder.

3. The composition of claim 2, wherein the binder is used in an amount of 1˜8 wt %, based on the total weight of the composition.

4. The composition of claim 1, wherein the carbon nanofibers have an average length of 0.5˜30 μm.

5. The composition of claim 1, wherein the carbon fiber precursor comprises one or more selected from the group consisting of polyacrylonitrile (PAN), phenol-resin, polybenzylimidazole (PBI), cellulose, phenol, pitch, and polyimide (PI).

6. The composition of claim 1, wherein the carbon nanofibers are prepared by subjecting the spinning solution comprising the carbon fiber precursor and a thermally labile polymer to electrospinning, stabilization and carbonization.

7. The composition of claim 1, wherein the cathode active material is LiMn₂O₄ or activated carbon.

8. The composition of claim 1, wherein the electricity storage device is a lithium secondary battery or a lithium ion capacitor.

9. A cathode for an electricity storage device, comprising:
a collector; and
a cathode active material layer applied on the collector,
wherein the cathode active material layer is formed of the composition for producing a cathode of any one of claims 1.

10. An electricity storage device, comprising a cathode, an anode, and an electrolyte, wherein the cathode is the cathode of claim 9.

11. The electricity storage device of claim 10, which is a lithium secondary battery or a lithium ion capacitor.

12. A method of preparing a composition for producing a cathode for an electricity storage device, comprising:
(a) electrospinning a spinning solution including a carbon fiber precursor, thus preparing a nanofiber web;
(b) subjecting the nanofiber web prepared in (a) to oxidative stabilization in air;
(c) subjecting the oxidative stabilized nanofiber web prepared in (b) to carbonization in an inert gas atmosphere or in a vacuum;
(d) grinding carbon nanofibers obtained in (c); and
(e) mixing the carbon nanofibers ground in (d) with a cathode active material, a conductive material and a binder thus preparing a slurry.
